(19) United States
(12) Patent Application Publication
(10) Pub. No.: US 2010/0175155 A1
(43) Pub. Date: Jul. 8, 2010

(54) Measurement and Mapping of Molecular Stretching and Rupture Forces

(75) Inventor: Ozgur Sahin, Cambridge, MA (US)

Correspondence Address: MODERN TIMES LEGAL, ONE BROADWAY , 14TH FLOOR, CAMBRIDGE, MA, 02142, US

(73) Assignee: PRESIDENT AND FELLOWS OF HARVARD COLLEGE, Cambridge, MA (US)

(21) Appl. No.: 12/652,925

(22) Filed: Jan. 6, 2010

Related U.S. Application Data
(60) Provisional application No. 61/142,804, filed on Jan. 6, 2009.

(51) Int. Cl. G01Q 20/02; G01Q 60/24

(52) U.S. Cl. 850/6; 850/33; 850/5

(57) ABSTRACT

Detection and localization of stretching and rupture of targets (e.g., macromolecules) is achieved using time-varying tip-sample force measurements in a dynamic-mode atomic force microscope. The detection and localization is achieved with an independent force sensor that can detect and distinguish stretching and rupture forces acting on a sensor device as the tip of the sensor device traverses a surface, wherein the stretching and rupture forces are temporally distinct from forces between the tip and the substrate.

### RELATED APPLICATION

This application claims the benefit of U.S. Provisional Application No. 61/142,804, filed Jan. 6, 2009, the entire content of which is incorporated herein by reference.

### BACKGROUND

The detection and localization of stretching and rupture of macromolecules has the potential to offer new methods for material characterization and molecular biological studies. Atomic force microscopes and atomic force microscopy (AFM) are a class of instruments and imaging methods in which a sharp tip attached to the end of a flexible cantilever is scanned across a sample surface to map topographical features and various material properties. AFM can also be used to detect and localize stretching and rupture of macromolecules.

A variety of atomic force microscopy is the tapping mode where a flexible cantilever is vibrated at one of its resonance frequencies in the vicinity of the sample. Vibration amplitude and other parameters of the cantilever motion are monitored to map the topography and material properties of the sample. The gentle interaction between the tip and the sample in tapping-mode atomic force microscopy has made it the dominant operation modality of atomic force microscopy.

Torsional harmonic cantilevers (also referred to as coupled torsional cantilevers) for tapping-mode atomic force microscopy are specially designed cantilevers that can be used as a replacement for conventional cantilevers. When used in the tapping mode, these cantilevers enable measurement of instantaneous forces between the vibrating tip and the sample. A detailed description of this cantilever can be found in the following reference: O. Sahin, et al., “An Atomic Force Microscope Tip Designed to Measure Time-Varying Nanomechanical Forces,” Nat. Nanotechnol. 2, 507-14 (2007). Another cantilever designed to enable the measurement of instantaneous forces between the vibrating tip and the sample can be found in the following reference: A. F. Sarioglu, et al., “Cantilevers with Integrated Sensor for Time-Resolved Force Measurement in Tapping-Mode Atomic Force Microscopy,” Applied Physics Letters 93, 023114 (2008); and U.S. Pat. Nos. 7,089,787; 7,302,833; and 7,404,314. These cantilevers have a primary and a secondary force sensor. The primary force sensor relies on the measurement of vertical vibration amplitude of the cantilever, which is similar to conventional AFM cantilevers. The secondary sensor has a wider mechanical detection bandwidth (i.e., a higher resonance frequency), and hence a faster response time, compared to the primary force sensor. In the case of torsional harmonic cantilevers, the secondary sensor relies on the detection of torsional deflections (twisting). In the work of Sarioglu et al., the secondary sensor relies on the modulation of reflected laser power by an integrated diffraction grating.

### SUMMARY

Described herein are methods and apparatus for detecting molecular stretching and/or rupture forces between a sensor device and targets (e.g., molecules) on a substrate. The sensor device includes a tip for interacting with the substrate surface, a primary force sensor for detecting contact between the tip and the surface, and a secondary force sensor for detecting stretching or rupture between the sensor device and the targets. The secondary force sensor provides a signal for the stretching and rupture that is independent from and that can be measured independently of the signal from the primary force sensor.

In operation, the tip of the sensor device traverses the substrate surface in a tapping mode. As the tip traverses the surface, the primary force sensor tracks surface topography, while the secondary force sensor, which has a faster response, detects molecular stretching and/or rupture when a target is contacted. Stretching and rupture of macromolecules between the tip (or another part of the sensor device) and the substrate can be detected by differentiation of waveform features in the measurements by the secondary force sensor; and the analysis can be performed on un-averaged waveform features.

The methods of detecting stretching and rupture forces, described herein, can provide new functionality and the advantages of greater sensitivity and specificity in detection as well as the capacity for use with high-Q cantilevers. The methods and apparatus can also be used to probe a previously unexplored regime of thermally activated dissociation of molecular complexes, wherein molecules bind and are pulled apart on the microsecond timescale. The dramatic enhancement in speed offered by the methods and apparatus also enable chemically specific imaging techniques.

### BRIEF DESCRIPTION OF THE DRAWINGS

FIG. 1 is a schematic illustration of tapping-mode atomic force microscopy.

FIG. 2 is an illustration of a torsional harmonic cantilever including an offset tip to detect time-varying tip-sample forces during the vertical vibrations of the cantilever across a substrate surface and tensile forces associated with bonding between the tip and targets on the substrate surface.

FIG. 3 shows a torsional harmonic cantilever that includes a spacer and a probe molecule secured to the tip, wherein the probe molecule has bonded with a target molecule on the substrate.

FIG. 4 illustrates movement of a laser spot reflecting of the top side of the torsional harmonic cantilever as it interacts with the surface.

FIG. 5 is a mapped output of recorded tensile forces (white) occurring where a biotin probe molecule bonded with streptavidin molecules distributed sparsely across a cleaved-mica substrate surface scanned in the tapping mode.

FIG. 6 includes an illustration of a non-binding interaction and plots of the cantilever position (top) and a force waveform (bottom), which show that forces on the vibrating cantilever are localized in time to the duration of the contact when there is no binding between a tip and a target.

FIG. 7 includes an illustration of a binding interaction and plots of the cantilever position (top) and a force waveform (bottom), which show that the polymer is stretched and that additional interaction forces are observed when the tip is away from the surface and when the tip and a target are bound.

FIG. 8 illustrates a sequence of positions of a tip on a cantilever and a polymer spacer and probe molecule attached to the tip over an oscillation of the cantilever as it passes over a substrate and as the probe molecule bonds to a target on the substrate; the approximate sinusoidal path of the tip is plotted with the dashed line, and corresponding force (up for compression and down for tension) and time plots are provided beneath the illustrated sequence.

FIG. 9 includes three plots of measured tip-sample waveforms for a cantilever with a spacer and a biotin probe molecule, wherein plots (B) and (C) show rupture events of biotin and streptavidin, and wherein the cantilever is subject to a larger oscillation in plot (B) than in plot (C), resulting in the length of the spacer being covered via retraction of the tip in a shorter time period so that the tensile force appears closer (in time) to the repulsive peak; for comparison, plot (A) shows another waveform recorded in the absence of streptavidin.

FIG. 10 is an illustration of an alternative embodiment, wherein molecules bound to stretchable spacers are attached to a substrate, and the binding partner of these molecules are linked to the tip.

In the accompanying drawings, like reference characters refer to the same or similar parts throughout the different views. The drawings are not necessarily to scale, emphasis instead being placed upon illustrating particular principles, discussed below.

### DETAILED DESCRIPTION

The foregoing and other features and advantages of various aspects of the invention(s) will be apparent from the following, more-particular description of various concepts and specific embodiments within the broader bounds of the invention(s). Various aspects of the subject matter introduced above and discussed in greater detail below may be implemented in any of numerous ways, as the subject matter is not limited to any particular manner of implementation. Examples of specific implementations and applications are provided primarily for illustrative purposes.

Unless otherwise defined, terms (including technical and scientific terms) used herein have the same meaning as commonly understood by one of ordinary skill in the art to which this invention belongs. It will be further understood that terms, such as those defined in commonly used dictionaries, are to be interpreted as having a meaning that is consistent with their meaning in the context of the relevant art and are not to be interpreted in an idealized or overly formal sense unless expressly so defined herein. For example, if a particular composition is referenced, practical, imperfect realities may apply; e.g., the potential presence of at least trace impurities (e.g., at less than 0.1% by weight or volume) can be understood as being within the scope of the description.

Although the terms, first, second, third, etc., may be used herein to describe various elements, these elements are not to be limited by these terms. These terms are simply used to distinguish one element from another. Thus, a first element, discussed below, could be termed a second element without departing from the teachings of the exemplary embodiments.

Spatially relative terms, such as “above,” “upper,” “beneath,” “below,” “lower,” and the like, may be used herein for ease of description to describe the relationship of one element to another element, as illustrated in the figures. It will be understood that the spatially relative terms are intended to encompass different orientations of the apparatus in use or operation in addition to the orientation depicted in the figures. For example, if the apparatus in the figures is turned over, elements described as “below” or “beneath” other elements or features would then be oriented “above” the other elements or features. Thus, the exemplary term, “above,” may encompass both an orientation of above and below. The apparatus may be otherwise oriented (e.g., rotated 90 degrees or at other orientations) and the spatially relative descriptors used herein interpreted accordingly.

Further still, in this disclosure, when an element is referred to as being “on,” “connected to” or “coupled to” another element, it may be directly on, connected or coupled to the other element or intervening elements may be present unless otherwise specified. The terminology used herein is for the purpose of describing particular embodiments and is not intended to be limiting of exemplary embodiments. As used herein, the singular forms “a,” “an” and “the” are intended to include the plural forms as well, unless the context clearly indicates otherwise. Additionally, the terms, “includes,” “including,” “comprises” and “comprising,” specify the presence of the stated elements or steps but do not preclude the presence or addition of one or more other elements or steps.

In embodiments described herein, stretching and rupture events are detected with a high-bandwidth independent, secondary force sensor. As used herein, the “stretching” can be linear, torsional, flexural, etc. The secondary force sensor can respond to forces at both low and high frequencies (e.g., from 10 kHz to 1 MHz), and the secondary force sensor can be used to detect stretching and rupture events in macromolecules and can accordingly be used to identify and localize biological molecules as well as to characterize polymeric materials. In principle, an atomic force microscope can be used to detect these forces, and the independent/secondary force sensor can take a variety of forms. For example, in one embodiment, the independent, secondary force sensor is incorporated into a cantilever with a diffraction grating. In another embodiment, the independent, secondary force sensor is incorporated into a torsional harmonic cantilever.

An example of the first embodiment—i.e., a cantilever with a diffraction grating—is described in A. F. Sarioglu, et al., “Cantilevers with Integrated Sensor for Time-Resolved Force Measurement in Tapping-Mode Atomic Force Microscopy,” Applied Physics Letters 93, 023114 (July 2008). The diffraction grating is in the form of a small and stiff mechanical resonator with interdigitated fingers on the cantilever, wherein adjacent fingers have λ/8 offset and wherein λ is the illumination wavelength; and the diffraction grating can provide the temporal resolution for observing probe-sample binding interactions.

In operation, the cantilever is driven close to its fundamental resonance frequency. During a small fraction of the oscillation cycle, the tip interacts with the sample. The diffraction grating responds to the stretching and rupture forces, whereas the larger and softer cantilever does not follow efficiently because of its lower bandwidth. The distinctive response of the diffraction grating to these forces compared with the cantilever body causes the relative position of the diffractive grating fingers to change, modifying the amount of light in the diffraction modes. Measuring the variation in light intensity in the diffracted modes enables observation of the stretching and rupture events.

For the purpose of exemplification, the remainder of this discussion focuses primarily on embodiments in which the independent, secondary force sensor is in the form of a torsional harmonic cantilever, though we begin by discussing forms of atomic-force microscopy.

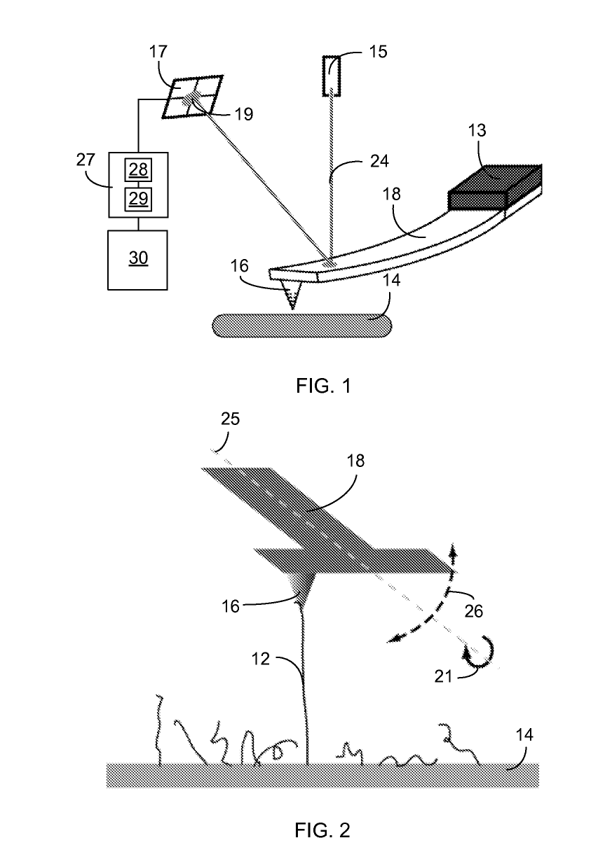

In an embodiment of tapping-mode atomic-force microscopy (illustrated in FIG. 1), the cantilever 18 is excited via a piezoelectric element 13 to vibrate at its resonant frequency; and a tip 16 on the cantilever 18 is brought close to the sample surface, which includes a sample substrate 14 and target molecules thereon. The substrate can be nearly any type of structure, even a cell, for example. The tip 16 is moved across the surface of the sample substrate 14 (e.g., via one or more displacement motors) so that the tip 16 traverses substantially all of the substrate 14 (e.g., by traversing a sequence of rows that are spaced sufficiently close to enable binding between the tip 16 (or to a probe molecule attached to the tip) and substantially all target molecules that are on the substrate 14 in or between the rows of the path traversed by the tip 16 across the substrate surface.

Intermittent contact of the tip 16 on the cantilever 18 with the surface alters the amplitude and phase of the cantilever vibration. The vibrations are detected with an optical system where a laser beam 24 from a laser 15 reflects from the back of the cantilever 18 and then falls onto a position-sensitive photodetector 17. The laser spot 19 moves up and down on the photodetector 17 as the cantilever 18 vibrates, and the photodetector 17 measures and transmits the occurrence and position of the light from the laser spot 19 on the photodetector 17. Analysis of displacement of the laser spot 19 from the secondary force sensor can be based on detection of features in the waveform over a single vertical oscillation cycle of the cantilever.

As is further shown (schematically) in FIG. 1, an input port of a computer 27 is coupled with the photodetector 17 (e.g., by wire or wirelessly) to receive the transmitted readings of laser spot 19 positions from the photodetector 17. The computer 27 (e.g., a personal computer running, for example, a Windows, Apple or Linux operating system) includes input and output ports, a computer-readable storage medium (e.g., a magnetic hard drive) 29, and a computer processor 28 coupled with the input and output ports (e.g., USB ports) and the computer-readable storage medium 29.

The computer 27 can also be coupled via an additional port with a displacement motor (not shown) at the base of the cantilever to provide a feedback mechanism that adjusts the height of the cantilever base so that the vibration amplitude is maintained at a set-point value slightly below the free amplitude per instructions encoded in the software (i.e., if the vibration amplitude is above the set-point value, the cantilever is raised further above the substrate surface; and if the vibration amplitude is below the set-point value, the cantilever is lowered to a position closer to the substrate surface). As the cantilever 18 is scanned across the substrate 14, the feedback signal is used to map the topography of the sample surface. The tapping cantilever 18 vibrates approximately in a sinusoidal trajectory. The amplitude and phase of this trajectory are the two primary observables.

Tapping-mode microscopy methods (e.g., AC-mode, dynamic-mode, etc.), however, do not directly detect the forces between the tip and the sample. The primary physical quantities being measured are the vibration amplitude and phase of the cantilever. These quantities are not directly related to specific molecular interaction forces. Instead, these quantities respond to the overall interaction between the tip 16 and the sample substrate 14, which is a combination of repulsive forces due to the tip hitting the sample, electrical forces due to surface charges in liquids, van der Waals forces, and molecular interactions. While the latter is of interest to detect and localize macromolecular stretching and rupture, the measured physical quantities do not directly reveal these interactions. In practice, using vibration amplitudes to locate molecular rupture events and also to measure binding/unbinding forces during the scanning process (though possible) has accordingly proven difficult.

The methods and apparatus described herein can overcome the above-described limitations and can also enable efficient mapping (locating) of stretching or rupture events, as well as the measurement of molecular unbinding forces. Each time the offset tip 16 contacts the surface of the substrate 14 while vibrating, the force acting on the tip 16 twists the cantilever 18 about its central (longitudinal) axis 25 (see FIG. 2). When a target molecule on the substrate 14 attaches to the tip 16 or vice versa, however, a temporally distinct torsional motion 21 in a reverse direction about the central axis 25 of the cantilever 18 occurs.

The forces due to the stretching or rupture of the target molecule arise when the oscillating tip 16 is away from the surface of the substrate 14. The interactions between the tip 16 and the substrate 14, on the other hand, occur when the tip 16 is at its lowest point in its oscillatory motion. Therefore, macromolecular stretching and rupture events happen at different times than interactions between the tip 16 and the substrate 14. The secondary force sensor, which has a fast temporal response, can distinguish these force components. The primary force sensor also is affected by the molecular stretching and rupture forces; however, separation of the stretching and rupture forces from other tip-sample interaction forces is difficult.

Temporal differentiation of the rupture events from other interactions allows molecular rupture events to be identified and mapped across the surface by measuring interaction forces during the times when the oscillating tip is away from the surface. The magnitude of these forces also provide a measure of unbinding or rupture forces of the macromolecule. Temporal differentiation of rupture forces can be detected by the torsional motion of a torsional harmonic cantilever (THC) that has a high bandwidth, making it sensitive to time-varying probe-sample forces.

In the embodiment of FIG. 2, the tip 16 is mounted to the cantilever 18 and offset from the central axis 25 of the cantilever 18 (e.g., by about 20 μm). As shown, the tip 16 is also bound to a target 12 on the substrate 14. The torsional motion 21 of the oscillating cantilever 18 is used as a secondary force sensor having a wide mechanical bandwidth, whereas the vertical oscillation 26 of the cantilever 18 serves as the less-responsive primary force sensor. The wide-bandwidth force measurements from the secondary force sensor can be used to reconstruct time-varying tip-sample force waveforms. In the embodiment of FIG. 2, a spacer between the tip 16 and target molecule 12 is not needed because the target molecule 12, itself, attaches to the tip 16 via adsorption and unravels and extends as the tip 16 retracts away from the substrate 14 to then generate tension when the target molecule 12 is fully extended.

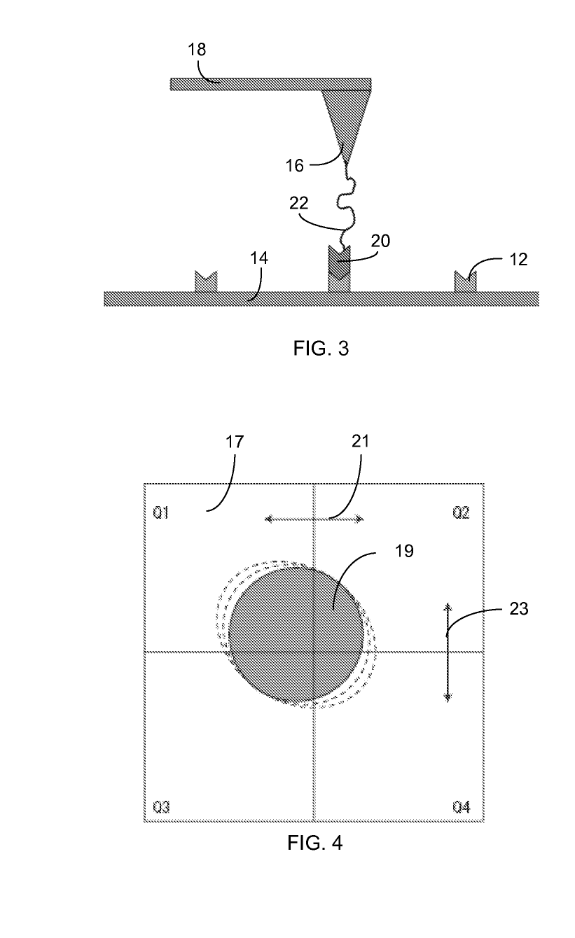

The fact that target molecules 12 and/or the cantilever 18 can be stretched (e.g., longitudinally or flexurally) with external forces before a rupture, unbinding, or detachment occurs is utilized to detect and locate those target molecules 12. In the case of dynamic atomic-force-microscope operation, a molecular stretching or a rupture event can occur if a target molecule 12 on the sample substrate 14 attaches to the sharp tip 16 of a cantilever 18 or to a probe molecule 20 attached to the tip 16 via a spacer 22 during the imaging process, as shown in FIG. 3. In the embodiment of FIG. 3, the spacer 22 unravels after the probe molecule 20 binds to the target molecule 12 to provide a delay before the binding between the probe molecule 20 and the target molecule 12 is ruptured.

The most-commonly observed tip-sample forces dominantly act on the tip 16 when the tip 16 is at the bottom of its trajectory—i.e., while indenting the sample; examples of these forces include indentation forces or van der Waals forces. On the other hand, because the tensile forces due to binding appear when the tip 16 is retracting from the surface and when the tip is away from the surface equilibrium level, the rupture event occurs at a different time than the occurrence of these other interaction forces.

When the cantilever 18 is vibrated in the tapping mode (as shown by oscillation arrow 26 in FIG. 2), tip—sample interaction forces generate a torque around the central axis 25 of the cantilever and excite the torsional modes (as shown by torsional arrow 21 n FIG. 2). Torsional motions 21 move the laser spot 19 (shown in FIGS. 1 and 4) horizontally on the photodetector 17, as shown by arrow 21 in FIG. 4, while flexural movements of the cantilever 18 move the laser spot vertically on the photodetector 17, as shown by arrow 23 in FIG. 4. As in the case of the conventional tapping-mode atomic force microscopy, flexural (vertical) vibration signals are used for amplitude feedback to follow topography. Simultaneously, torsional vibration signals are used for the calculation of the time-resolved tip—sample interaction forces, as discussed below.

Analysis of high-frequency torsional and flexural vibrations of the tapping cantilever involves modeling the cantilever as a continuum mechanical element with multiple vibration modes. Following the framework used by M. Stark, et al., in “Inverting Dynamic Force Microscopy: From Signals to Time-Resolved Interaction Forces,” Proc. Natl Acad. Sci., USA 99, 8473-78 (2002), the tip—sample interaction is treated as a feedback force on cantilever displacement. This allows the tapping cantilever to be represented by a linear system (equivalent to the response of a cantilever fixed at the base and free near the tip). This cantilever is driven by two external forces: tip—sample forces and the driving force of the oscillation.

In one embodiment, a commercial atomic-force-microscopy system (Multimode series, equipped with Nanoscope 4 controller, Veeco Instruments, Inc, signal break-out box, and torsional vibration detection electronics) is used in these methods. An additional lock-in amplifier (Stanford Research Systems, SRS-844), a digital oscilloscope and a data acquisition card (NI DAQ, S-series) are also incorporated into the system.

The flexural and torsional vibration signals can be recorded with the data acquisition card in a computer 27 (shown in FIG. 1). The computer 27 includes a computer-readable storage medium 29 includes software code that, when executed by the processor 28, detects a displacement of the laser spot 19 indicative of a tensile force (caused by bonding between a probe molecule on the tip 16 and a target molecule on the substrate 14). The software code also includes instructions for recording the displacement of the laser spot 19 over time and as a function of the position of the tip 16 over the substrate 14 and generating a map of the positions on the substrate where a tensile force indicative of the presence of a target molecule 12 was generated and for transmitting that map through the output port of the computer 27 to an output device 30, such as a computer monitor or a computer printer, that then displays the generated map.

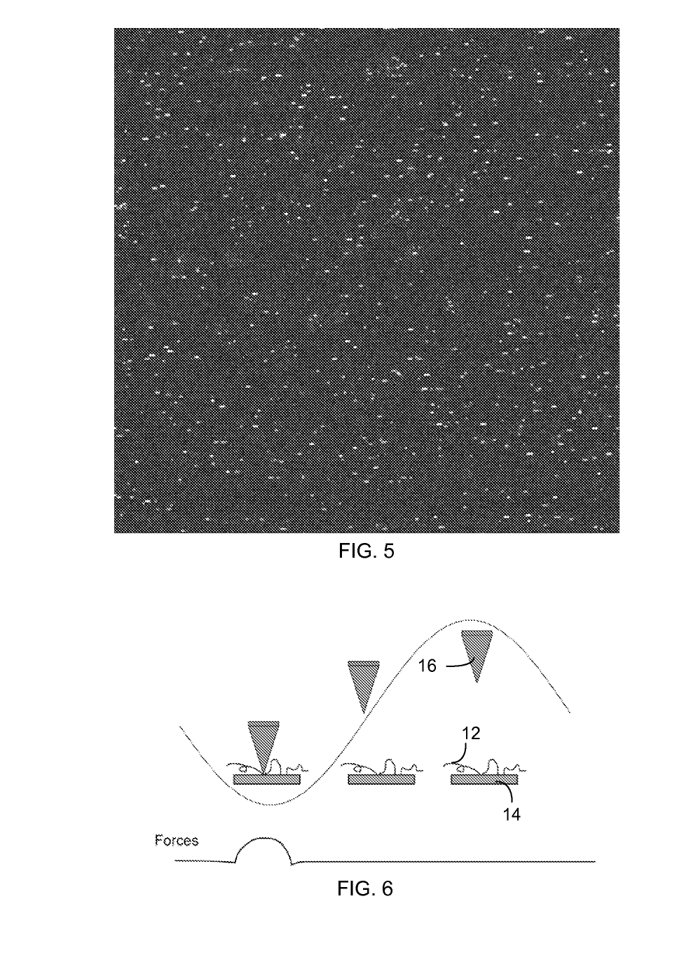

An example of the generated map of target molecules is provided in FIG. 5, which represents the mapped output of recorded tensile forces occurring when a biotin probe molecule binds with streptavidin molecules distributed sparsely across a cleaved-mica substrate surface scanned in the tapping mode. Forces are coded into color or contrast, wherein light patches are seen where biotin-streptavidin interaction occurred.

The flexural and torsional (vertical and lateral) signals generated by the quadrant photodetector can be low-pass-filtered with a cutoff frequency, e.g., of 2 MHz, and can be continuously downloaded to the computer with the data acquisition card. A LabVIEW software program (from National Instruments) can be stored in the computer-readable medium 29 to perform digital signal processing to obtain tip-sample force waveforms. The software also includes instructions for signal processing to correct cross-talk from the primary force sensor into the secondary force sensor, as described in O. Sahin, et al., “An Atomic Force Microscope Tip Designed to Measure Time-Varying Nanomechanical Forces,” Nat. Nanotechnol. 2, 507-14 (2007). The computer-readable medium 29 also includes software instructions for determining whether a torsional displacement is indicative of a tensile force above a threshold value occur, thereby indicating the stretching and rupture of a bound target molecule 12, at a particular time after the peak displacement caused by contact between the tip 16 and the substrate 14.

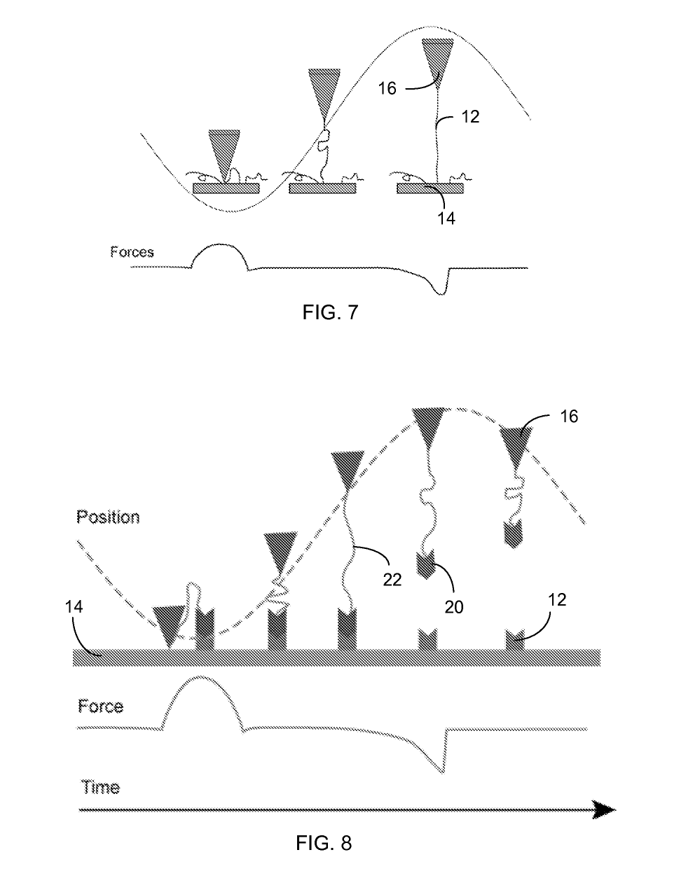

Accordingly, because the forces associated with stretching or rupture appear at a time distinct from the occurrence of the common tip-sample interaction forces that are located around the lowest point of tip trajectory, and by analyzing the tip-sample force waveform to search for a temporally distinct feature on the waveform (i.e., a force that pulls the tip down), one can locate a stretching or rupture event and measure the associated force apart from the tip-substrate interactions. A comparison of tip-sample force waveforms without and with stretching or rupture events is illustrated in respective FIGS. 6 and 7.

In FIG. 6, where the macromolecule 12 does not attach to the tip 16, the position of the cantilever 18 in time is illustrated with a sinusoidal curve. The force waveform has one dominant pulse per oscillation period (shown towards left), which is due to the interactions of the tip 16 with the substrate 14. Accordingly, an observer or a computer can evaluate the force waveform to detect interaction forces when the oscillating tip 16 is away from the sample 14 and thereby identify the existence or, in this case, absence of molecular stretching and rupture events.

In FIG. 7, a macromolecule 12 attaches to the tip 16; and the macromolecule 12 is stretched, and additional interaction forces are observed when the tip 16 is away from the surface 14. These additional interaction forces appear in the force waveform as a second pulse distinct from the earlier pulse corresponding to the contact between the tip and the sample;

the two pulses are temporally segregated. Accordingly, this time-varying force measurement reveals whether there is a macromolecular stretching and rupture event and also the magnitude of the rupture force, which is the peak negative force in the second pulse.

In addition to the general identification of stretching and rupture events via observation of the time-varying forces and the search for attractive forces when the tip is away from the sample, the process can also be customized to investigate specific molecules. Molecule-specific customization can be achieved by functionalizing the cantilever tip 16 with molecules of interest.

A binding and unbinding sequence is shown in FIG. 8 for a tip 16 secured to a polymer spacer 22, such as polyethyleneglycol (PEG), of a desired length and a probe molecule 20 (e.g., a ligand) at the end of the spacer 22. The length of the spacer 22 can be designed so that the interaction between the probe molecule 20 and the target molecules 12 (e.g., a receptor) can be readily recognized. In this sequence, the probe molecule 20 first binds to the target molecule 12 (at far left); then, as the tip 16 retracts from the substrate 14, the polymer spacer 22 is extended and stretched, and the rupture occurs between the third and fourth step (toward the right) due to the unbinding of the probe molecule 20 and the target molecules 12. A plot of the force on the tip 16 is plotted beneath the illustrated sequence along with a correlated time plot. The repulsive force on the tip 16 due to the initial impact between the tip 16 and the substrate 14 is seen in the hump to the left, and the tensile force extending to the unbinding of the probe molecule 20 from the target molecule 12 is seen in the trough (i.e., a tensile force) to the right. The force measured just before unbinding represents the strength of the receptor-ligand interaction. The entire sequence from the impact of the tip on the substrate through the rupture of the probe molecule 20 and the target molecule 12 takes about 100 μs or less.

In other examples, one can attach a probe molecule of interest 20 (e.g., in the form of an antibody, a protein, a nucleic acid, etc.) to a polymer spacer 22 (formed, e.g., of polyethylene glycol, single- or double-stranded DNA, peptide nucleic acids or locked nucleic acids) that can extend under external force. In one embodiment, the probe molecule 20 is an antibody, and the target molecule 12 is an antigen; in an alternative embodiment, the probe molecule 20 is an antigen, and the target molecule 12 is an antibody. In another embodiment, the probe molecule 20 is a ligand and the target molecule 12 is a receptor.

The polymer spacer 22 enlarges the distance of stretching and, therefore, further increase the time difference between the tip-substrate interactions and macromolecular stretching and rupture events. If the spacer 22 is made shorter, the tensile force on the tip occurs closer in time to the force of impact between the tip 16 and the substrate 14; and if the spacer 22 is made longer, a larger gap occurs between impact and unbinding. Polymer spacers 22 can have lengths around 2-100 nanometers or more. This time difference enhances detection specificity, though the methods discussed herein for detection of the temporally distinct stretching due to binding can be carried out without the spacer.

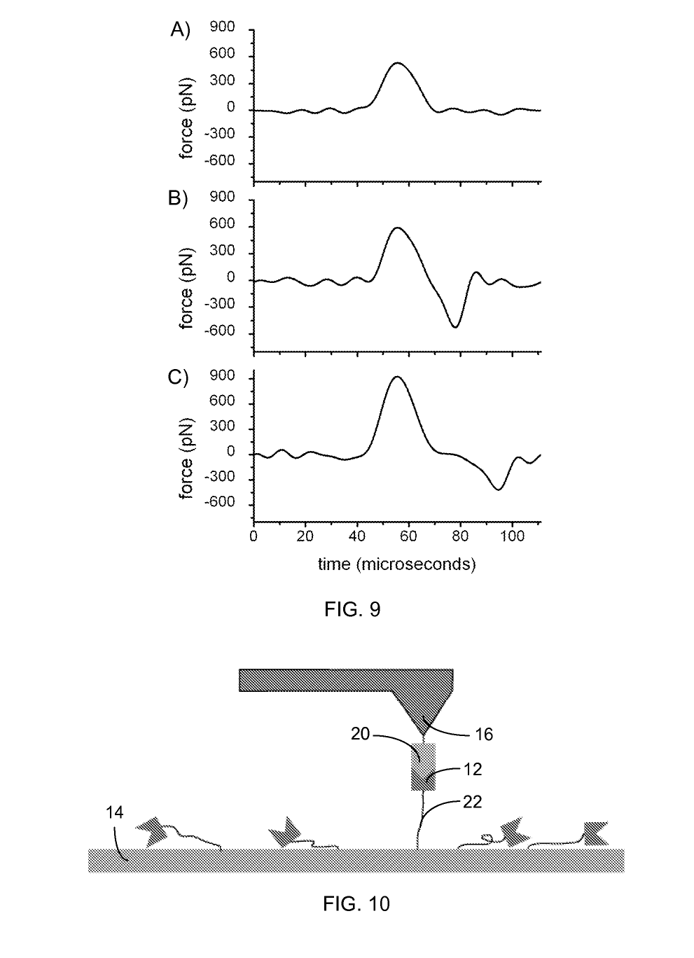

A series of force plots acting on a tip with a spacer and probe molecule over time is provided in FIG. 9. In plot (A), the tip is passed over an area with no target molecules; therefore no tension peak due to binding and rupture is evident. Nevertheless, the repulsive force peak at about 55 μs is evident here, as in the other plots, due to the impact of the tip on the substrate, though other variations in the measured force (evident as small waves in the plot) are simply background noise. In plot (B), a tension peak (in the form of a trough) is seen immediately after the repulsive force peak at just under 80 μs. Meanwhile, in plot (C), a repulsive force peak and tension peak are again evident; though in this case, the amplitude of the vertical oscillations of the cantilever oscillations was reduced; consequently, the smaller oscillation amplitude extended the length of time needed for the length of the spacer to be covered, which caused the tensile force to be pushed further (in time) from the repulsive peak.

The waveforms provided in FIG. 9 are obtained using a torsional harmonic cantilever having a vertical spring constant of approximately 0.11 N/m and vertical resonance frequency equal to 9.5 KHz as measured in aqueous buffer. The torsional resonance frequency of this torsional harmonic cantilever is equal to 115 KHz. The effective spring constant of the torsional mode, defined by ratio of the tip displacement in the torsional mode to the force acting on the tip, is approximately 0.98 N/m. Using a vertical spring constant around 0.1 N/m and effective torsional spring constant provides sufficient force sensitivity to resolve waveform features arising from molecular stretching and rupture events. Using a lower effective torsional spring constant can improve the force sensitivity further.

In other embodiments, target molecules 12 to be measured can be attached with flexible polymer spacers 22 to the surface of a substrate 14, and the binding-partner probes 20 for these molecules can be linked to the tip (with or without additional polymer spacers), as shown in FIG. 10. This configuration yields a waveform where the rupture event or the stretching of the polymer spacer results in an additional force interaction when the tip is away from the sample. In additional embodiments, another structure or molecule, for example, found in the surrounding medium (e.g., a solution) can attach both to the target molecule 12 and to the tip 16 to form a bond between them.

These methods can be used to investigate rupture forces between molecules. One primary application for these techniques is testing drugs by attaching the drugs to the tip via polymer spacers and scanning them over target molecules or biological cells.

In describing embodiments of the invention, specific terminology is used for the sake of clarity. For the purpose of description, specific terms are intended to at least include technical and functional equivalents that operate in a similar manner to accomplish a similar result. Additionally, in some instances where a particular embodiment of the invention includes a plurality of system elements or method steps, those elements or steps may be replaced with a single element or step; likewise, a single element or step may be replaced with a plurality of elements or steps that serve the same purpose. Further, where parameters for various properties are specified herein for embodiments of the invention, those parameters can be adjusted up or down by 1/100^{th}, 1/50^{th}, 1/20^{th}, 1/10^{th}, ⅕^{th}, ⅓^{rd}, ½, ¾^{th}, etc. (or up by a factor of 2, 5, 10, etc.), or by rounded-off approximations thereof, unless otherwise specified. Moreover, while this invention has been shown and described with references to particular embodiments thereof, those skilled in the art will understand that various substitutions and alterations in form and details may be made therein without departing from the scope of the invention. Further still, other aspects, functions and advantages are also within the scope of the invention; and all embodiments of the invention need not necessarily achieve all of the advantages or possess all of the characteristics described above. Additionally, steps, elements and features discussed herein in connection with one embodiment can likewise be used in conjunction with other embodiments. The contents of references, including reference texts, journal articles, patents, patent applications, etc., cited throughout the text are hereby incorporated by reference in their entirety. Appropriate components and methods of those references may be selected for the invention and embodiments thereof. Still further, the components and methods identified in the Background section are integral to this disclosure and can be used in conjunction with or substituted for components and methods described elsewhere in the disclosure within the scope of the invention. In method claims, where stages are recited in a particular order—with or without sequenced prefacing characters added for ease of reference—the stages are not to be interpreted as being temporally limited to the order in which they are recited unless otherwise specified or implied by the terms and phrasing.

I claim:

1. A method for detecting stretching or rupture forces comprising:
providing an atomic-force microscopy apparatus including a sensor device comprising:
a) a tip for interacting with a substrate surface;
b) a primary force sensor for detecting contact between the tip and the surface; and
c) a secondary force sensor for detecting stretching or rupture between the sensor device and the target;
oscillating the tip;
traversing the oscillating tip across the substrate surface; and
using the secondary force sensor to detect stretching or rupture between the sensor device and any targets on the substrate surface.

2. The method of claim 1, wherein the secondary force sensor detects binding of the sensor device and at least one target by detecting a tensile force over a single oscillation of the tip.

3. The method of claim 2, wherein the secondary force sensor detects the tensile force at a time offset from a force peak that occurs when the tip contacts the substrate.

4. The method of claim 2, wherein the tensile force is expressed over less than 100 microseconds.

5. The method of claim 2, further comprising comparing the tensile force with a threshold representing a maximum tensile force arising from non-binding interactions between the sensor device and the substrate and identifying the presence of the target based on whether the tensile force is greater than the threshold.

6. The method of claim 2, further comprising:
measuring the magnitude of the tensile force; and
identifying the composition of target based on the magnitude of the tensile force.

7. The method of claim 1, wherein a plurality of targets reside on the substrate surface, and wherein the secondary force sensor detects the stretching or rupture between the sensor device and the plurality of targets.

8. The method of claim 1, wherein the tip is mounted on a cantilever that is vibrated to oscillate the tip in a tapping mode.

9. The method of claim 8, wherein the tip is offset from a central axis of the cantilever.

10. The method of claim 9, wherein the primary force sensor detects contact by monitoring vertical deflections of the cantilever, and wherein the secondary force sensor monitors torsional deflections of the cantilever.

11. The method of claim 1, wherein targets bond directly with the tip.

12. The method of claim 1, wherein targets bond with the tip via a flexible polymer spacer.

13. The method of claim 12, wherein the spacer includes at least one of polyethylene glycol, single-stranded DNA, double-stranded DNA, peptide nucleic acids and locked nucleic acids.

14. The method of claim 12, wherein a probe molecule is bound to the flexible polymer spacer and the targets bind with the probe molecule.

15. The method of claim 1, further comprising using force feedback from the primary force sensor to maintain the relative height of the sensor device with respect to the sample surface.

16. The method of claim 1, wherein the sensor device binds with a target including a biological molecule.

17. The method of claim 1, wherein the sensor device includes an antigen or antibody probe that binds with an antibody or antigen target on the substrate surface.

18. The method of claim 1, further comprising mapping the location of detected targets on the substrate.

19. An apparatus for measuring molecular stretching and rupture comprising a sensor device including:
a cantilever having a central axis;
a mechanism coupled with the cantilever to oscillate the cantilever along its central axis;
a tip at one end of the cantilever to contact a surface when the cantilever is oscillated and passed over the surface, wherein the tip is offset from the central axis of the cantilever to generate torsion in the cantilever when the tip contacts the surface; and
a spacer coupled with tip.

20. The apparatus of claim 19, further comprising a laser and a photodetector, wherein the laser is positioned and configured to direct light onto the cantilever and the photodetector is positioned and configured to detect the light after it interacts with the cantilever.

21. The apparatus of claim 20, further comprising a computer in communication with the photodetector to receive output from the photodetector, the computer including:
a processor; and
a computer-readable medium in communication with the processor, the computer-readable medium storing software code for:
a) monitoring the output of the photodetector to identify displacements of the light that represent tensile forces acting on the tip due to binding with targets on a surface of a substrate;
b) determining whether the detected tensile forces exceed a threshold for distinguishing non-binding tensile forces;
c) recording the position of the cantilever when tensile forces are identified that exceed the threshold; and
d) generating a map correlating the recorded positions and the identified tensile forces to indicate where the targets are found on the surface of the substrate.
